(19) United States
(12) Patent Application Publication
(10) Pub. No.: US 2003/0163902 A1
(43) Pub. Date: Sep. 4, 2003

(54) Carpet slide for recreational use

(76) Inventor: Donald V. Edwards, Irwin, PA (US)

Correspondence Address: CAROTHERS AND CAROTHERS, Suite 500, 445 Fort Pitt Blvd., Pittsburgh, PA, 15219, US

(21) Appl. No.: 10/233,366

(22) Filed: Sep. 3, 2002

Related U.S. Application Data
(63) Continuation-in-part of application No. 10/086,282, filed on Mar. 4, 2002.

(51) Int. Cl. E05B 1/00

(52) U.S. Cl. 16/422

(57) ABSTRACT

A carpet slide for securement to ones foot as a recreational entertainment device. The slide includes a sheet of material having an upturn perimeter edge and it is secured to the sole of an athletic shoe or a two piece strap is secured to opposite perimeter edges for securing ones foot to the upper surface of the slide. This securing strap is constructed of hook and loop strapping for securement to the slide and about to the upper portion of ones foot using two straps of such material.

### CROSS REFERENCE

This application is a continuation-in-part of U.S. application Ser. No. 10/086,282 filed Mar. 4, 2002.

### BACKGROUND OF THE INVENTION

The present invention pertains to slides for recreational use which are applied to the feet of the participant for sliding on carpet.

The present invention is directed to a pair of slides for securement to ones feet as a recreational entertainment device which permits the participant to slide on slippery carpet surfaces. An object of the present invention is to provide such a slide which is economical to manufacture and provides easy and exciting use for the participant.

### SUMMARY OF THE INVENTION

The carpet slide of the present invention is comprised of a sheet of material, preferably plastic, having top and bottom faces and an upturn perimeter edge to prevent catching of the edges on carpet surfaces. A mechanism is provided for easily securing a foot to the upper surface of each sheet.

In one embodiment, this means for securing the sheet or slide to the foot includes a two piece strap secured at opposite ends to the upturned perimeter edge of the sheet. This two piece strap has an adjustable securing mechanism, such as a buckle, or more preferably a hook and loop fastener arrangement, for adjustably securing the two strap pieces together over ones foot for tight securement.

The top face is preferably provided with a non-slip surface.

The bottom face of the sheet is also preferably convex for more efficient and faster sliding contact with the carpet surface over which the participant intends to slide.

In another embodiment, the means provided for securing the carpet slide to one's foot may take on the form of a shoe, such as an athletic shoe, wherein the sole of the shoe itself is the sheet of material utilized as the carpet slide.

Also, in order to ensure good traction on an underlying carpet surface when the carpet slides are in use for playing such games as carpet hockey, transverse sawtooth ribs are provided on the forward toe portion of the bottom surface of the slide sheet for providing walking or running traction. These ribs have sawtooth ridges which face toward the rearward heel portion of the slide on the bottom surface of the slide for thereby providing a gripping action as the player moves forward, yet the sawtooth configuration permits the player to slide forward and sideways on the carpet. This gives the participant more control, particularly when playing a game such as hockey on a carpeted surface.

### BRIEF DESCRIPTION OF THE DRAWINGS

Other objects and advantages appear hereafter in the following description and claims. The drawings show, for the purpose of exemplification, without limiting the invention or appended claims, certain practical embodiments of the present invention wherein:

FIG. 1 is a plan view of the carpet slide of the present invention without the inclusion of the securing strap for securing the slide to ones foot;

FIG. 2 is a view in side elevation of the carpet slide shown in FIG. 1;

FIG. 3 is a view in mid cross section of the carpet slide shown in FIGS. 1 and 2 as seen along section line III-III of FIG. 2;

FIG. 4 is another plan view of the apparatus of the present invention shown in FIG. 1 with the inclusion of the securement straps for securing the device to ones foot;

FIG. 5 is a perspective view in section as viewed along section V-V of FIG. 4 showing the detail of the attachment of the securement strap to the perimeter edge of the carpet slide.

FIG. 6 is a bottom view of the carpet slide shown in FIG. 1 with transverse sawtooth ribs on the forward toe portion of the slide for providing walking or running traction;

FIG. 7 is a view in side elevation of the carpet slide shown in FIG. 6; and

FIG. 8 is a perspective view illustrating the slide of FIGS. 6 and 7 integrally secured as a sole piece to an athletic shoe.

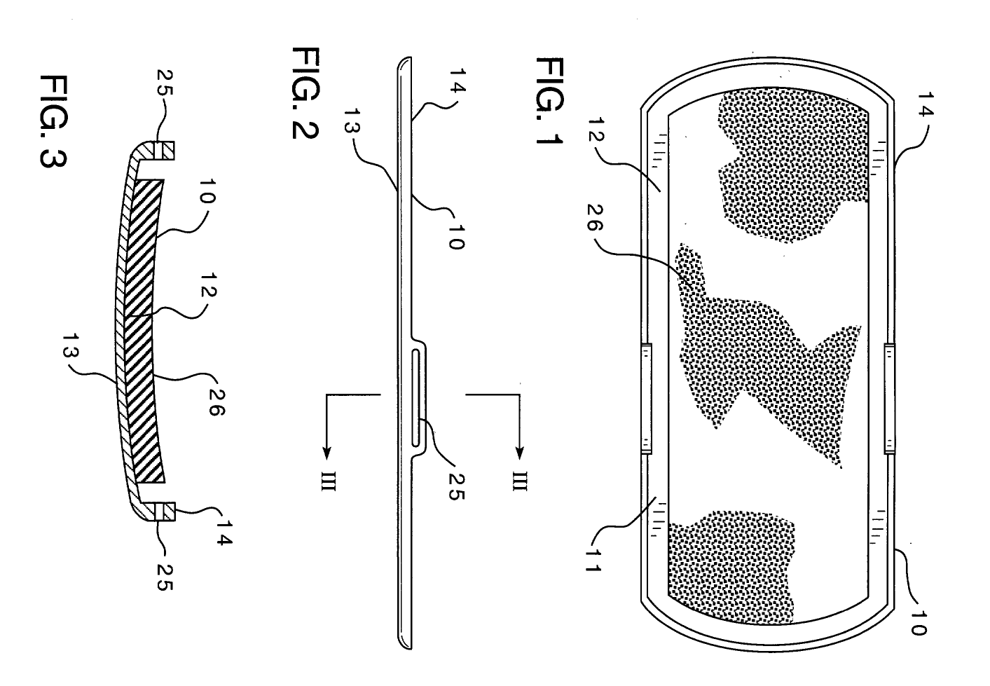

### DESCRIPTION OF A PREFERRED EMBODIMENT

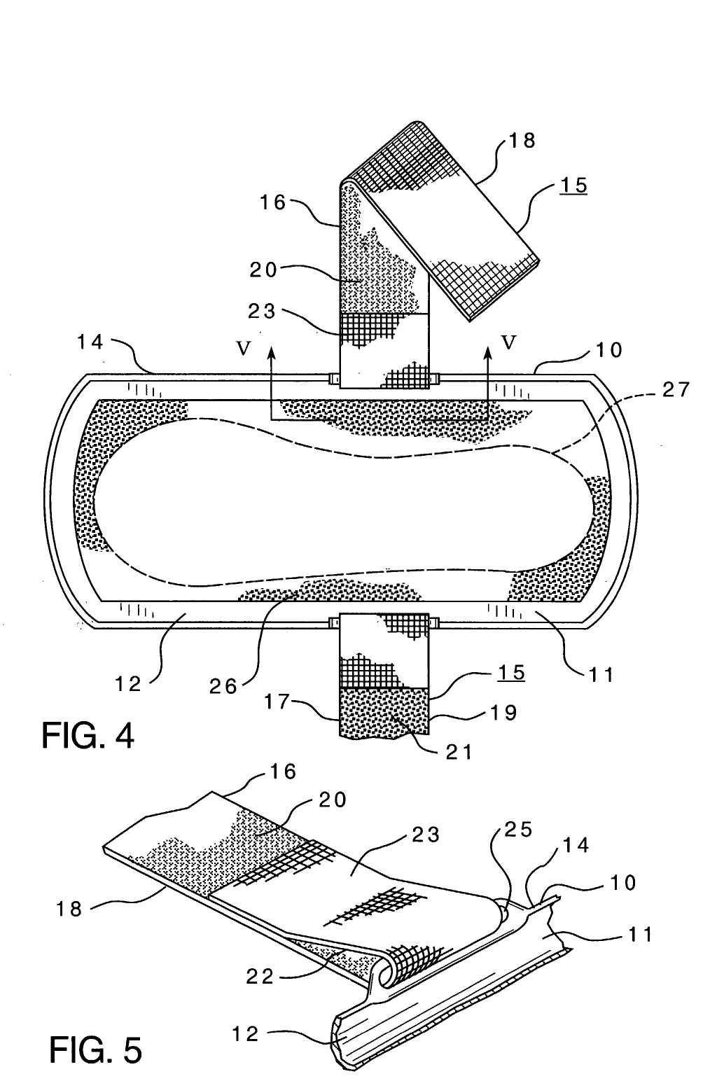

Turning to the drawings, the carpet slide 10 of the present invention is comprised of a sheet 11 of plastic material having top and bottom faces 12 and 13 respectively and an upturned perimeter edge 14. As seen best in FIGS. 4 and 5, means 15 in the form of a two piece strap having strap segments 16 and 17 with hook and loop material applied for securing the strap segments to the perimeter edge 14 and also for securing the loose ends 18 and 19 together. Strap 16 is provided with hook material 20 for securement to the loop surface 21 of strap 17.

In similar fashion, the under surface 22 of terminating end 23 of strap 16 is also provided with loop material to engage loop material 20 after terminating end 23 has been passed through aperture 25 of upturn perimeter edge 14.

Strap 17 connects to the perimeter edge 14 in the same fashion, except that the hook and loop surfaces are reversed.

The bottom surface 13 of sheet 11 is also made to be convex in order to provide minimal surface contact with the carpet surface over which the carpet slide is to be used. This provides minimal contact area and less friction and a more enjoyable sliding experience.

The upper surface 12 is also provided with a nonslip surface 26 in the form of a foam pad to help prevent ones foot, as indicated by dashed outline 27, from slipping on the upper surface 12. Other non-skid surfaces may be substituted.

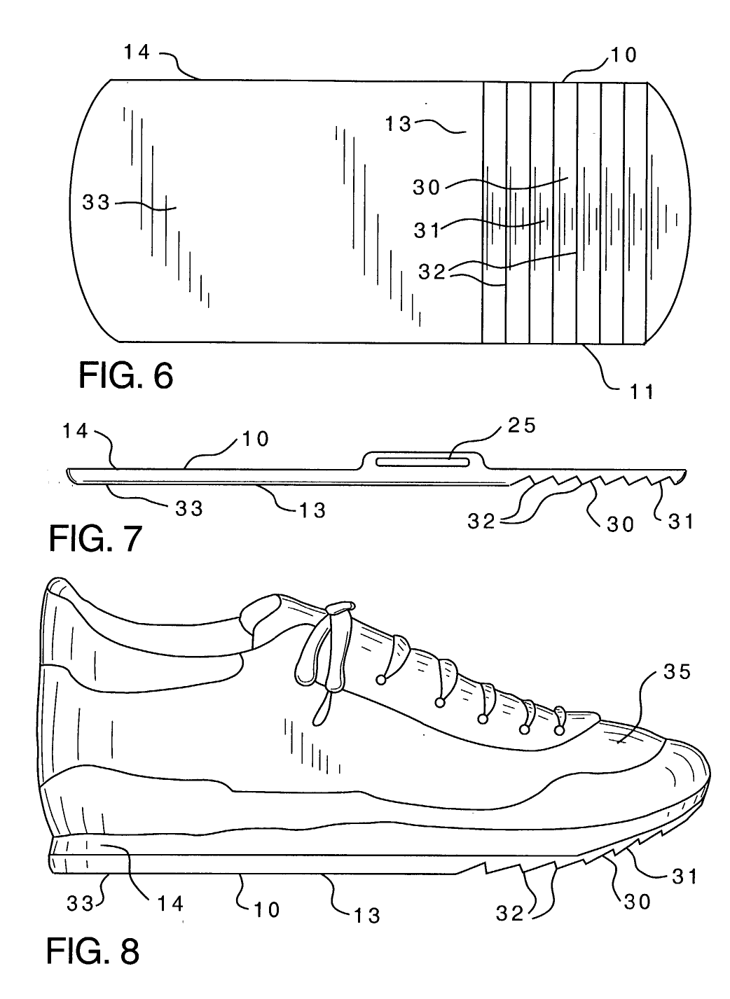

Referring next to FIGS. 6 and 7, a modification of the carpet slide shown in the previous figures is illustrated wherein the carpet slide 10 includes transverse sawtooth ribs 30 on the forward toe portion 31. These ribs are of a sawtooth configuration having ridges 32 which face to or toward the rearward heel portion 33 of the bottom surface 13.

Thus, as the participant moves forward by walking or running when playing an athletic event, such as hockey, the sawtooth ribs 30 will dig into the carpet surface and provide traction. Yet by reason of the fact that the ridges 32 face rearward, this permits the participant to easily slide forward or to the side, when desired, on the carpeted surface.

Referring next to FIG. 8, another modification of the present invention is illustrated wherein the means for securing the carpet slide 10 to ones foot is accomplished through the use of a conventional athletic shoe 35. The top face 13 of the slide itself is permanently glued directly to the sole of the shoe and provides a permanent sole for the shoe 35.

A preferable material for the carpet slide 10 is a slippery flexible plastic, such as manufactured under the trademark Teflon.

I claim:

1. A carpet slide for securement to ones feet as a recreational entertainment device, said slide comprising;
a sheet of material having top and bottom faces and an upturned perimeter edge; and
means for securing a foot to said upper surface.

2. The carpet slide of claim 1, wherein said bottom face convex.

3. The carpet slide of claim 1, wherein said means for securing includes a two piece strap secured at opposite ends thereof to said upturned perimeter edge and having adjustable securing means for adjustably securing the two strap pieces together over a foot.

4. The carpet slide of claim 3, wherein said adjustable securing means is comprised of a hook and loop fastener.

5. The carpet slide of claim 1, wherein said sheet is plastic.

6. The carpet slide of claim 1, including a non-slip surface on said upper face for nonslip engagement with the foot of a wearer.

7. The carpet slide of claim 1, wherein said means for securing includes a shoe having a bottom sole and wherein said upper surface is secured to said bottom sole.

8. The carpet slide of claim 1, including transverse sawtooth ribs on a forward toe portion of said bottom surface for providing walking and running traction on a surface, said ribs having sawtooth ridges facing toward a rearward heel portion of said bottom surface.
